(19) United States
(12) Patent Application Publication
(10) Pub. No.: US 2026/0359142 A1
(43) Pub. Date: Nov. 12, 2026

(54) SYSTEM AND METHOD FOR OFFLOADED TASK COMPUTATION THROUGH LOAD BALANCING IN FOG-ENABLED IoT NETWORK

(71) Applicant: IMAM MOHAMMAD IBN SAUD ISLAMIC UNIVERSITY, Riyadh (SA)

(72) Inventors: Abdul Khader Jilani SAUDAGAR, Riyadh (SA); Muhammad Awais JAVED, Islamabad (PK); Ahmad Naseem ALVI, Islamabad (PK); Mubarak ALBATHAN, Riyadh (SA)

(73) Assignee: IMAM MOHAMMAD IBN SAUD ISLAMIC UNIVERSITY, Riyadh (SA)

(21) Appl. No.: 19/200,256

(22) Filed: May 6, 2025

(51) Int. Cl. G06F 9/50; G06F 9/48

(52) U.S. Cl. CPC G06F 9/5083; G06F 9/4887

(57) ABSTRACT

A system and a method for balancing task execution load of a plurality of fog servers in an Internet of Things (IoT) network includes generating, by IoT nodes, application-related tasks with respective predetermined computation time deadlines. The method further includes receiving, by a load balancing node, IoT tasks offloaded from the IoT nodes and forwarding these tasks to the fog servers in a runtime environment. The method further includes performing, by the fog servers, the offloaded IoT tasks within the respective predetermined computation time deadlines. By dynamically balancing workloads, the method prevents server overloading, enhances system efficiency, and improves reliability. Additionally, the method maximizes the number of executed tasks while minimizing energy consumption, making it suitable for resource-constrained environments.

### BACKGROUND

### Technical Field

The present disclosure is directed to Internet of Things (IoT) networks, and more particularly to a system and a method for offloaded task computation through load balancing in a fog-enabled IoT network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Integration of Internet of Things (IoT) technologies with wireless communication systems, data transmission, and machine learning has significantly transformed modern machine-to-machine communication. These advancements have facilitated seamless access to information and enabled remote control of devices through a unified platform. Consequently, the number of IoT devices connected to the Internet has increased exponentially, leading to an unprecedented surge in data generation and computational demands.

Conventionally, cloud computing has played a central role in supporting IoT technologies by providing centralized computing resources to handle data processing and analytics, as well as communication. However, as a centralized solution, cloud computing faces limitations in addressing the ultra-low latency requirements of modern IoT applications. High network congestion, excessive data transmission delays, and increased energy consumption associated with cloud-based processing have made it challenging to meet the real-time processing needs of latency-sensitive IoT applications.

Fog computing has emerged as a decentralized computing paradigm aimed at mitigating the limitations of cloud computing by bringing computational resources closer to IoT nodes. By leveraging edge servers located near the data sources, fog computing reduces latency, improves response times, and alleviates the burden on centralized cloud servers. In fog computing networks, IoT devices offload computational tasks to nearby fog nodes, enabling more efficient processing and resource utilization.

Despite the advantages of fog computing, challenges related to computational offloading and resource allocation among the fog computing resources remain significant. The unbalanced distribution of workloads among fog nodes leads to inefficient utilization of available resources, increased processing delays, and potential task failures. Existing approaches for task offloading involve carefully determining the task size and selecting the optimal location for offloading to fog nodes to achieve desired performance objectives. Offloading decisions may treat tasks as indivisible entities (e.g., binary offloading) or divide them into smaller subtasks for partial offloading. While partial offloading offers greater flexibility, it is often more complex to implement, making binary offloading the preferred approach in many time-constrained scenarios.

Furthermore, IoT tasks are typically time-sensitive and may be executed within predefined deadlines to ensure system reliability and performance. Failure to execute tasks within their respective deadlines may lead to severe consequences, particularly in critical applications such as healthcare monitoring, smart traffic management, and industrial automation. The limited computational and energy resources of fog nodes further complicates the problem, necessitating the development of efficient load-balancing mechanisms that prioritize task execution based on real-time network conditions.

Accordingly, it is one object of the present disclosure to provide a system and method of allocating fog nodes to offloaded deadline-based internet-of-things (IoT) tasks. It is a further object to provide a load balancer for efficient distribution of computational load in a network of IoT nodes. It is a further object of the present disclosure to take into consideration factors such as link capacity in addition to load on fog nodes in load balancing.

### SUMMARY

In an exemplary embodiment, a system for balancing task execution load of a plurality of fog servers in an Internet of Things (IoT) network is described. The system includes a plurality of IoT nodes, the plurality of fog servers, and a load balancing node. The plurality of IoT nodes are configured to generate application-related tasks with respective predetermined computation time deadlines. Further, the plurality of fog servers are configured to provide computation resources for performing offloaded IoT tasks within the respective predetermined computation time deadlines. Further, the load balancing node is configured to receive all offloaded tasks from the plurality of IoT nodes and forward these tasks to the plurality of fog servers in a runtime environment.

In another exemplary embodiment, a method for balancing task execution load of a plurality of fog servers in an Internet of Things (IoT) network that includes a plurality of IoT nodes is described. The method includes generating, by the plurality of IoT nodes, application-related tasks with respective predetermined computation time deadlines. The method includes receiving, by a load balancing node, IoT tasks offloaded from the plurality of IoT nodes and forwarding these tasks to the plurality of fog servers in a runtime environment. The method further includes performing, by the plurality of fog servers, the offloaded IoT tasks within the respective predetermined computation time deadlines.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary architecture of a system configured for balancing task execution load of a plurality of fog servers in an Internet of Things (IoT) network, according to certain embodiments.

FIG. 2 is an exemplary block diagram of the system configured for balancing the task execution load of the plurality of fog servers in the IoT network, according to certain embodiments.

FIG. 3 is an exemplary flow diagram of a method for balancing the task execution load of the plurality of fog servers in the IoT network, according to certain embodiments.

FIG. 4A illustrates a Technique for Order of Preference by Similarity to Ideal Solution (TOPSIS) score calculation algorithm, according to certain embodiments.

FIG. 4B illustrates a task allocation algorithm, according to certain embodiments.

FIG. 5 is another exemplary flow diagram of a method for balancing the task execution load of fog servers in the IoT network, according to certain embodiments.

FIG. 6 is an illustration of a non-limiting example of details of computing hardware used in a computing device, according to certain embodiments.

FIG. 7 is an exemplary schematic diagram of a data processing system used within the computing device, according to certain embodiments.

FIG. 8 is an exemplary schematic diagram of a processor used with the computing device, according to certain embodiments.

FIG. 9 is an illustration of a non-limiting example of distributed components that may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

It is noted that the terms “fog nodes”, “fog servers”, and “fog computing devices” are used interchangeably for computing devices in a fog layer.

The rapid expansion of the Internet of Things (IoT) has led to an exponential increase in the number of connected devices generating real-time data and requiring greater computational resources for processing. IoT applications, such as smart cities, healthcare monitoring and autonomous vehicles, and demanding low-latency processing to ensure timely decision-making. Conventionally, cloud computing has been used to handle such computational tasks for IoT applications. However, its centralized nature introduces latency and bandwidth constraints, making it unsuitable for time-sensitive applications.

To address these challenges, fog computing has emerged as a distributed computing model that places computational resources closer to IoT devices. By offloading tasks to nearby fog nodes instead of distant cloud servers, fog computing reduces latency and improves network efficiency. However, the effectiveness of fog computing is often hindered by an unbalanced distribution of computational tasks among fog nodes. Some fog nodes become overloaded while others remain underutilized, leading to increased processing delays, inefficient resource utilization, and potential service disruptions. Furthermore, many existing task allocation methods do not adequately consider factors such as task deadlines, limited computational capacity, and residual energy usage of fog nodes, resulting in missed deadlines and suboptimal task execution.

The present disclosure aims to address the abovementioned issues by providing a system and a method for resource allocation to fog nodes to execute tasks within their deadlines. An object of the present disclosure is to provide a solution to an unbalanced load distribution problem among multiple fog servers for efficient load distribution in a network of IoT nodes. Furthermore, an object of the present disclosure is to allocate the computational resources of multicore fog nodes to offloaded tasks within a deadline. A further object is to reduce the latency due to communication delay and computational delay of IoT tasks and compute the maximum number of tasks within their deadline.

Aspects of the present disclosure are directed to a system and a method for balancing task execution load of fog nodes in an Internet of Things (IoT) network. By performing balancing of the task execution load among fog nodes, the method ensures that tasks are executed efficiently without overloading any single fog node while meeting the required deadlines for task completion. This approach is particularly beneficial for real-time applications such as smart cities, healthcare monitoring, autonomous vehicles, and industrial automation, where timely data processing is important.

In the system, IoT devices such as sensors, cameras, appliances, vehicles and other connected devices generate tasks that require computational processing. Especially in the case of mission important applications, each task comes with a predefined deadline, making it important to allocate computing resources efficiently. Instead of immediately sending IoT tasks directly to fog servers, the IoT devices offload their tasks to a load balancing node. The load balancing node is important in analyzing the available computing power, workload, and energy levels of different fog servers before making an informed decision on task allocation to a fog server.

Once the load balancing node receives the IoT tasks, it dynamically assigns them to the most suitable fog server based on factors such as current workload, processing power, and available energy. This ensures that no single fog server is overwhelmed while others remain underutilized. By distributing the workload efficiently, the system prevents bottlenecks and optimizes the use of computational resources in the fog layer. Further, after the tasks are assigned, the IoT tasks are transmitted to the fog servers for execution. The fog servers prioritize received tasks to ensure that the tasks meet their respective deadlines. The system continuously monitors the execution process to maintain a balanced workload across all fog servers, significantly reducing processing delays and improving overall task execution efficiency.

The disclosed system and method provide several technical advantages. It ensures efficient task execution by completing tasks on time while preventing fog server overload. By dynamically distributing the workload, the system and method improve load balancing and improve computational resource utilization. The system and method also enhance energy efficiency by preventing unnecessary processing on fog servers, thereby extending their operational lifespan. Additionally, the system and method minimize overall processing delays, resulting in faster response times for IoT applications.

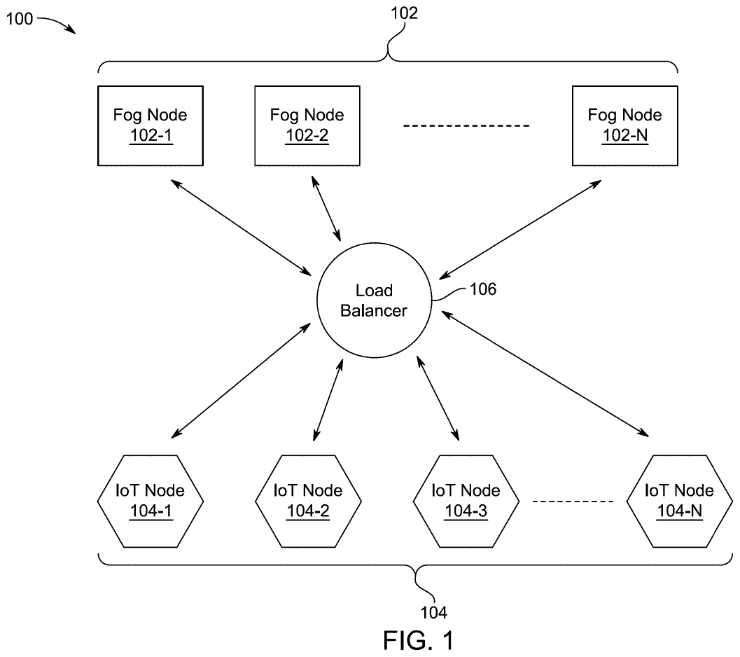

Referring now to FIG. 1, the present disclosure provides an exemplary architecture of a system 100 configured for balancing offloaded IoT task execution load of fog servers in fog layer, according to certain embodiments. The system 100 includes a layer of fog nodes (e.g., 102-1, 102-2, . . . , 102-N), a load balancer 106, and IoT nodes (e.g., 104-1, 104-2, . . . , 104-N) within communication range of the fog nodes. A person of ordinary skill in the art will understand that the fog nodes (102-1, 102-2 . . . 102-N) may collectively referred to as the fog nodes 102. Similarly, a person of ordinary skill in the art will understand that the IoT nodes (104-1, 104-2 . . . 104-N) may be collectively referred to as the IoT nodes 104.

In an embodiment, the fog nodes 102 (interchangeably referred to as fog servers), the load balancer 106 (interchangeably referred to as a load balancing node), and the IoT nodes 104 are connected with each other via a network (e.g., IoT network). In an embodiment, the network may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the IoT nodes 104 are configured to generate application-related tasks, each associated with specific computation time deadlines. The IoT nodes 104 may include autonomous vehicles equipped with one or more IoT sensors, which continuously generate real-time data for various applications such as navigation, traffic monitoring, collision avoidance, and environmental sensing. In some embodiments, these autonomous vehicles are embedded with multiple types of IoT sensors, including, but not limited to, Light Detection and Ranging (LiDAR), radar, Global Positioning System (GPS) modules, onboard cameras, ultrasonic sensors, and Inertial Measurement Units (IMUs), to collect extensive situational data.

For example, LiDAR sensors may generate high-resolution three-dimensional (3D) maps of the vehicle's surroundings, radar sensors detect objects at long distances, and ultrasonic sensors assist in parking and close-range obstacle detection. The autonomous vehicles frequently offload computationally intensive tasks such as object detection, path planning, and predictive analytics to fog nodes 102 within communication range for faster processing and reduced onboard computational load. Additionally, in some embodiments, real-time traffic congestion analysis may be performed using IoT-enabled vehicle-to-vehicle (V2V) and vehicle-to-infrastructure (V2I) communication, where data from multiple vehicles is aggregated and processed at the fog nodes 102 to optimize traffic flow. Similarly, in the case of an autonomous fleet management system, real-time data from multiple autonomous delivery vehicles may be offloaded to the load balancer 106, which assigns tasks such as route optimization, battery monitoring, and predictive maintenance scheduling to the most suitable fog nodes 102 based on available resources.

In an embodiment, each of the IoT nodes 104, having required tasks, offloads its computational tasks to the load balancer 106 for processing. The tasks generated by the IoT nodes 104 vary in complexity, execution time, and urgency. For example, an Artificial Intelligence (AI) based medical imaging analysis task may require 30 minutes to process. In contrast, a traffic congestion analysis task generated by IoT-based traffic sensors may need execution within 1 second to ensure real-time traffic management.

The load balancer 106 is a central server with direct access to all the tasks generated by the IoT nodes 104 and is also connected to the fog nodes 102. The role of the load balancer 106 is to assign tasks to one of its connected fog nodes 102. In particular, the load balancer 106 is configured to receive all offloaded tasks from the IoT nodes 104 and forward these tasks to the fog nodes 102 in a runtime environment.

The load balancer 106 ensures efficient distribution of computational load of IoT nodes and allocation of computational resources of multicore fog nodes to offloaded tasks. The load balancer 106 minimizes delay by evenly distributing offloaded tasks across the fog nodes 102. The load balancer 106 forwards incoming tasks to a fog node 102, which may execute them in a shortest time. In an embodiment, the IoT task distribution is based on a multicriteria decision-making approach, specifically a Technique for Order of Preference by Similarity to Ideal Solution (TOPSIS). The load balancer 106 evaluates multicriteria parameters before assigning IoT tasks to a particular fog node. The multicriteria parameters of the multicriteria decision-making include a link capacity between the load balancer 106 and the fog nodes 102 to ensure sufficient bandwidth for task transmission, a list of IoT tasks pending in a queue of the fog node 102 to prevent congestion and overloading, a number of under-processed tasks in execution to ensure even workload distribution, residual energy of the fog nodes 102, and a computing capability of each of the fog nodes 102, ensuring that the most capable fog node executes resource-intensive tasks.

In an embodiment, the load balancer 106 may calculate a TOPSIS score for each available fog node 102 before forwarding the IoT task. The offloaded task is then forwarded to the fog node with the highest score, ensuring minimum execution delay and optimal resource utilization. Once a IoT task is assigned to the fog node 102, the assigned task is executed according to its deadline constraints.

In an embodiment, the fog nodes 102 have substantially greater computing resources than IoT nodes 104 to execute the IoT tasks. Each of the fog nodes 102 is designed with limited energy and computational resources but may handle multiple tasks simultaneously by dynamically allocating its processing power among multiple cores. The fog nodes 102 are configured to provide computation resources for performing offloaded IoT tasks within the respective predetermined computation time deadlines.

Additionally, the fog nodes 102 may implement adaptive load-balancing mechanisms to optimize their processing power dynamically. In an alternative embodiment, the fog node (e.g., 102-1) may interact with another fog node (e.g., 102-2) in a collaborative processing framework, enabling task migration when a particular fog node reaches its capacity limit. This inter-fog communication ensures even workload distribution, reducing bottlenecks and system failures due to excessive computational load. In an embodiment, resource allocation within the fog nodes 102 is determined based on task size and task deadline. Larger tasks require more processing resources, and tasks with shorter deadlines are given priority in resource allocation over those with relatively longer deadlines. For example, if two tasks of equal size arrive at the fog node (e.g., 102-1), the one with the shorter deadline may receive a greater share of computational resources to ensure timely execution. The fog node 102-1 processes the task while accounting for propagation delays incurred during task transmission from the IoT node 104 to the load balancer 106 and then to the fog node 102-1. Once the execution is complete, the processed results are returned to the respective IoT nodes 104 within its deadline.

In an embodiment, the system 100 may perform computational resource assignment to different priority-based offloaded tasks in a balanced way to reduce their execution delay in a fog-enabled IoT network. The system 100 ensures the execution of the maximum number of offloaded tasks within their respective deadlines. The system 100 uses three different components in the network, including IoT tasks offloaded by the IoT nodes 104 with varying deadlines, the load balancing node 106 and the fog nodes 102 with limited energy and computational resources. Each IoT node 104 generates tasks by assigning deadlines to each task. The load balancing node 106 has a knowledge of signal strength, task load, residual energy and the computational resources of each of its connected fog nodes 102. The load balancing node 106 runs a multicriteria based algorithm to find the computing capabilities of the fog node. Further, a resource allocation algorithm runs on each fog node to execute the IoT tasks placed in its queue list to complete the tasks within their deadline. Thus, the system 100 provides efficient task offloading, load balancing, and deadline-aware resource allocation to ensure optimal execution of computational tasks.

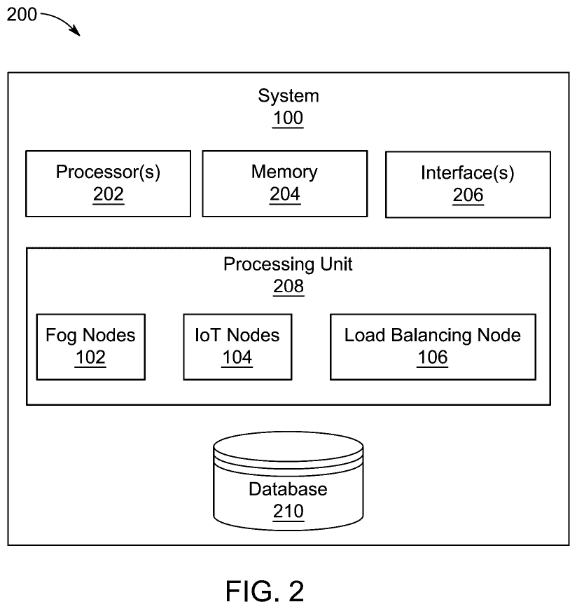

Referring now to FIG. 2, the present disclosure provides an exemplary block diagram 200 of the system 100 configured for development of a method of balancing the IoT task execution load of the fog servers 102 in the IoT network, according to certain embodiments.

In an embodiment, the system 100 may include one or more processor(s) 202. The one or more processor(s) 202 may be implemented as one or more microprocessors, microcomputers, microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 108. The memory 204 may be configured to store one or more computer-readable instructions or routines in a non-transitory computer readable storage medium, which may be fetched and executed to create or share data packets over a network service. The memory 204 may be a volatile memory, such as a Random-Access Memory (RAM), or a non-volatile memory, such as a Read Only Memory (ROM), an Erasable Programmable Read Only Memory (EPROM), a flash memory, and the like.

In an embodiment, the system 100 may include an interface(s) 206. The interface(s) 206 may include a variety of interfaces, for example, interfaces for data input and output devices (I/O), storage devices, and the like. The interface(s) 206 may facilitate communication through the system 100. The interface(s) 206 may also provide a communication pathway for one or more components of the system 100. Examples of such components include, but are not limited to, a processing unit 208, and a database 212.

In an embodiment, the processing unit 208 may be implemented as a combination of hardware and software (for example, programmable instructions) to implement one or more functionalities of the processing unit 208. In the examples described herein, such combination of hardware and software may be implemented in several different ways. For example, the software for the processing unit 208 may be processor-executable instructions stored on a non-transitory machine-readable storage medium, and the hardware for the processing unit 208 may include a processing resource (for example, one or more processors) to execute such instructions. In the present examples, the machine-readable storage medium may store instructions that, when executed by the processing resource, implement the processing unit 208. In such examples, the system 100 may comprise the machine-readable storage medium storing the instructions and the processing resource to execute the instructions, or the machine-readable storage medium may be separate but accessible to the system 100 and the processing resource. In an example, the processing unit 208 may be implemented by electronic circuitry.

In an embodiment, the database 210 may store data that may be generated as a result of functionalities implemented by any of the components of the processor(s) 202 or the processing unit 208. In an embodiment, the database 210 may be indicative of including, but not limited to, a relational database, a distributed database, a cloud-based database, or the like. In an exemplary embodiment, the processing unit 208 may include one or more units having functions that may include, but are not limited to, testing, storage, and peripheral functions, such as a wireless communication unit for remote operation and the like.

In an embodiment, the processing unit 208 may include a fog nodes 102, IoT nodes 104 and a load balancer 106 (interchangeably referred to as a load balancing node 106). To balance the task execution load of the fog servers (e.g., fog nodes 102) in the IoT network, the IoT nodes 104 are configured to generate application-related tasks with respective predetermined computation time deadlines. The IoT nodes 104 may be autonomous vehicles equipped with one or more IoT sensors. In particular, the IoT nodes 104 may include various IoT devices such as sensors, actuators, smart cameras, and connected vehicles, continuously generating data requiring real-time processing. The nature of the generated tasks may vary depending on the application domain, with some requiring instantaneous execution (e.g., collision avoidance in autonomous vehicles), while others may permit longer processing windows (e.g., periodic air quality analysis).

In an embodiment, each of the IoT nodes 104 may initiate the IoT tasks to estimate computational time deadline requirements. In an embodiment, the IoT tasks may include performing a traffic congestion analysis from traffic data generated by the one or more IoT sensors within a required computational time deadline of, for example 1 second.

To further elaborate, each task generated by the IoT nodes 104 may be associated with a specific computational deadline, ensuring that time-sensitive operations are completed within an acceptable timeframe. For example, an IoT-based traffic monitoring system may continuously analyze real-time traffic flow, detect congestion, and predict optimal traffic signal timings. This task requires instantaneous data processing to provide timely traffic control decisions, necessitating a computation time deadline of 1 second. Similarly, in healthcare applications, an Artificial Intelligence (AI)-based medical imaging system may analyze Magnetic Resonance Imaging (MRI) or Computed Tomography (CT) scan data to detect anomalies. This task, while computationally intensive, may have a longer deadline (e.g., 30 minutes) due to the non-immediate nature of the results. The IoT nodes 104 may determine the urgency and complexity of their generated tasks and assign execution deadlines accordingly before offloading them for processing.

Further, the tasks generated by the IoT nodes 104 are offloaded to the load balancing node 106 for optimized distribution among the available fog nodes 102. The load balancing node 106 may be configured to receive all offloaded tasks from the IoT nodes 104 and forward these tasks to the fog nodes 102 in a runtime environment.

Rather than allowing the IoT nodes 104 to directly communicate with the fog nodes 102, which may lead to unbalanced workloads and network congestion, the load balancer 106 ensures equitable task distribution by analyzing the current processing capacity, task queue, and energy levels of each of the fog nodes 102. This approach significantly improves system scalability, reduces latency, and enhances overall processing efficiency by allocating tasks to the most suitable fog node.

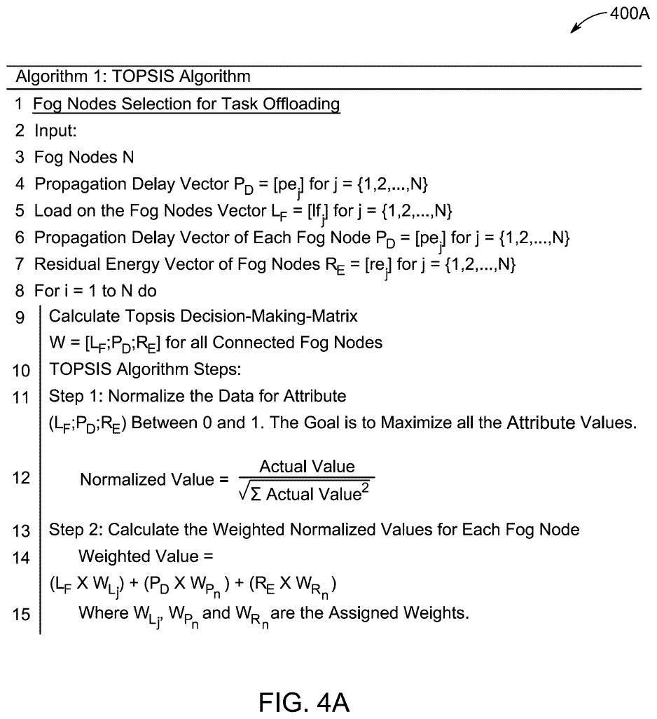

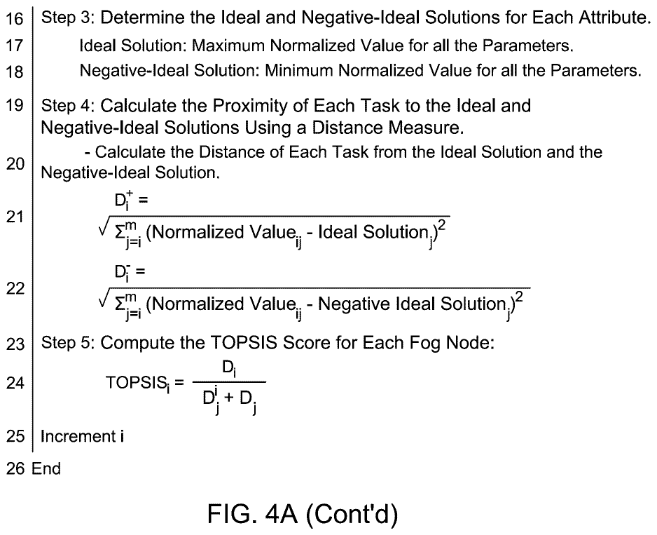

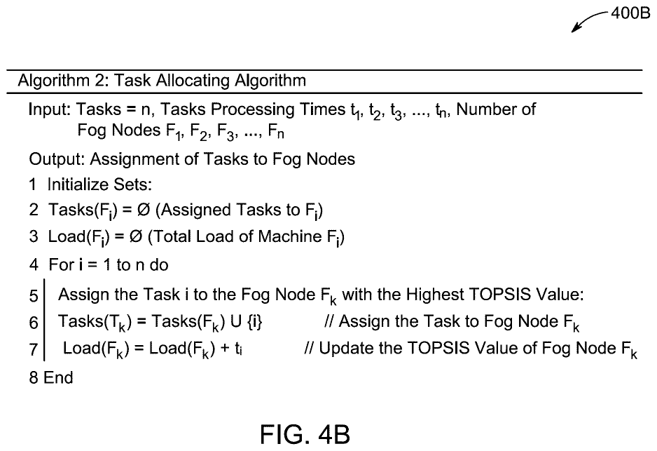

In an embodiment, the load balancing node 106 may be configured to maintain a Technique for Order of Preference by Similarity to Ideal Solution (TOPSIS) score for each of its connected fog nodes 102. This score is determined based on multicriteria decision-making that may assess the real-time computing capabilities, network conditions, and workload distribution across the fog nodes 102. To achieve optimal task distribution, the load balancing node 106 may be further configured to calculate the TOPSIS score for the load of the connected fog node and the link quality of the load balancing node 106 with the connected fog node. The TOPSIS score calculation algorithm is described in detail in conjunction with FIG. 4A.

In an embodiment, the TOPSIS score may be calculated based on multicriteria parameters, ensuring that selecting a suitable fog node aligns with the goal of minimizing processing delays and maximizing resource utilization. The multicriteria parameters may include link capacity between the load balancing node 106 and the fog nodes 102 (fog server), a list of tasks pending in a queue of the fog nodes 102, a number of under-processed tasks that are currently executing, residual energy of the fog node, and computing capacity of each of the plurality of fog nodes 102. The load balancing node 106 may be further configured to run a task allocation algorithm that forwards the received offloaded task to the fog nodes 102 with the highest TOPSIS score in order to provide a minimum computational delay. A task allocation algorithm for the load balancing node 106 (load balancer) is described in detail in conjunction with FIG. 4B, later below.

To achieve real-time adaptability, the load balancing node 106 may be further configured to run a multicriteria based algorithm to determine computing capacity for each of the fog servers (fog nodes 104). The load balancing node 106 may be further configured to maintain a record of signal strength, tasks load, residual energy and computational resources of each connected fog node. In an embodiment, maintaining the record of signal strength of each connected fog node and the load balancing node 106 ensures robust and low-latency data transmission. Further, maintaining the record of the current task load on each fog node helps in dynamically adjusting task allocation strategies. Further, maintaining the record of available residual energy of each of the fog nodes 102 prevents overloading of the low-energy fog nodes 102 and optimize energy efficiency. Additionally, maintaining the record of computational resources of each of the fog nodes 102 ensures that IoT tasks are distributed based on the processing power and available memory of the fog servers.

In an embodiment, the fog nodes 102 may be configured to provide computation resources for performing offloaded IoT tasks received from the IoT nodes 104 within the respective predetermined computation time deadlines. These fog nodes 102 may be deployed within the network to offer edge computing capabilities, reducing the need for sending large volumes of data to centralized cloud servers. By utilizing distributed computing, the fog nodes 102 may efficiently handle time-sensitive tasks while minimizing communication latency and network congestion.

Each fog node may be configured to allocate its available computing resources to each offloaded IoT task based on its computation time deadline. As the IoT nodes 104 generate tasks with varying computational complexities and deadlines, the fog nodes 102 prioritize resource allocation accordingly. For example, tasks with short and fixed deadlines, such as real-time traffic monitoring, healthcare diagnostics, and industrial automation, are allocated to higher computational resources to ensure timely execution. Conversely, IoT tasks with flexible deadlines, such as batch processing of environmental sensor data or periodic firmware updates, may be scheduled with lower priority to optimize overall resource utilization.

To ensure efficient IoT task execution, the fog nodes 102 may be further configured to run a resource allocation algorithm on each fog node to execute the IoT tasks placed in its queue list to complete them within their computation time deadline. The resource allocation algorithm evaluates multiple factors, including task priority, required computational power, available processing cores, memory availability, and energy consumption levels. Based on these factors, the resource allocation algorithm optimally schedules and assigns processing resources to tasks in the queue list of the fog nodes 102. This ensures that all IoT tasks are executed within their predefined computation time deadlines, reducing the likelihood of task failures due to resource exhaustion or processing delays.

Furthermore, the fog nodes 102 may be configured to handle multi-task execution using parallel processing capabilities. If a fog node is equipped with multicore processing units, it may distribute workloads among its cores to execute multiple tasks simultaneously, improving overall efficiency. Additionally, the resource allocation algorithm continuously monitors system load, execution time, and task completion rates to dynamically adjust resource distribution as per changing workload conditions. In scenarios where the fog node nears its resource capacity, it may trigger load balancing mechanisms to offload tasks to another fog node with available computing power, ensuring continuous task execution and preventing system failure.

Although FIG. 2 shows exemplary components of the system 100, in other embodiments, the system 100 may include fewer components, different components, differently arranged components, or additional functional components than depicted in FIG. 2. Additionally, or alternatively, one or more components of the system 100 may perform functions described as being performed by one or more other components of the system 100.

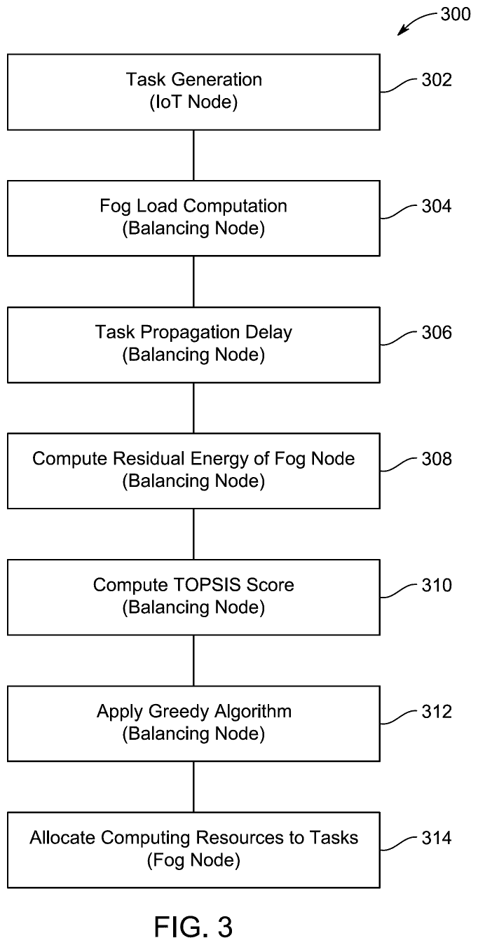

Referring now to FIG. 3, the present disclosure provides an exemplary flow diagram of a method 300 for balancing the task execution load of the fog servers in the IoT network, according to certain embodiments.

At step 302, the IoT nodes 104 may generate different application-related tasks along with their deadlines, and they require computational resources to execute these tasks within their deadlines. In an embodiment, the IoT nodes 104 may generate different application-related tasks along with their deadlines based on real-time data collection and predefined system requirements. Each of the IoT nodes 104 continuously monitors its environment using sensors, cameras, or other data acquisition devices. The collected data triggers the generation of specific computational tasks that need to be processed for further decision-making or control actions. The IoT tasks generated by the IoT nodes 104 vary in complexity, execution time, and urgency. For example, an Artificial Intelligence (AI) based medical imaging analysis task may require 30 minutes to process. In contrast, a traffic congestion analysis task generated by IoT-based traffic sensors may need execution within 1 second to ensure real-time traffic management.

At step 304, the load balancer 106 may calculate the load on each of its connected fog node 102. In an embodiment, a load on each fog node 104 is computed by taking the sum of the one or more parameters, such as Under Process Tasks Duration (DUP) and Unprocessed Pending Tasks Duration (DQ).

The DUP is calculated for the tasks under process. Each of the fog nodes 102 informs the load balancing node 106 when it initiates to process any new task. Duration of the under processed tasks DUP is calculated from the number of tasks that are under processed, computing capacity of the fog nodes 104, and the computational resources that are allocated to each of the offloaded task using an equation (1) defined below:

$$DUP = {\sum }_{k = 1}^{n} \frac{di}{Pi * R} - ti \qquad ( 1 )$$

In the equation (1), di represents the data of task i.
Pi is the percentage of computational resources allocated to task i.
R is the computing capacity of fog server.
ti represents the time passed since initiation of the task i.

The DQ is calculated against all those offloaded tasks that are pending in the queue list, and the execution process is yet to be initiated by the fog node 102. The load balancer 106 computes the duration required (DQ) in executing all its tasks placed in its queue using an equation (2) defined below:

$$DQ = {\sum }_{j = 0}^{n} \frac{dj}{R} \qquad ( 2 )$$

In equation (2), dj represents the data of task j.

At 306, the load balancer 106 determines the time needed to propagate the offloaded task to each of its connected fog nodes 102. The task propagation time (PT) of the task for the fog node is calculated using an equation (3) defined below:

$$PT = \frac{Di}{B * log 2 ( 1 + S / N )} \qquad ( 3 )$$

In the equation (3), Di represents the data size of the node i.
B represents the bandwidth in hertz of the communication channel for data transmission
S represents the received signal strength.
N represents the total channel noise power over the bandwidth B.

At step 308, the load balancing node 106 may compute residual energy of the fog nodes 102. The fog nodes 102 have limited energy resources, and their energy consumption directly relates to their computational power. The higher the allocation of computing resources, the more energy may be consumed. Each fog node 102 after regular intervals updates its residual energy to the load balancing node 106.

At step 310, the load balancer 106 may calculate the TOPSIS score of each of the connected fog node 102. The TOPSIS score of each fog node 102 is calculated by considering the load calculated in step 3 of FIG. 4A, the task propagation time of the load balancer 106 to each of the fog node 102 by following step 5 of FIG. 4A, and the residual energy of each fog node 102.

At step 312, the load balancer 106 may allocate the offloaded tasks among fog nodes 102 by applying a Greedy algorithm (as shown in FIG. 4B). The Greedy algorithm allocates the offloaded tasks on the basis of the TOPSIS value calculated against each of the fog nodes 102.

At step 314, each of the fog nodes 102 computes the received offloaded tasks. The fog node 102 allocates its processing resources to each of the offloaded tasks by considering their deadline. The percentage of resource allocation for task i (RAi) with deadline (dli) is calculated using an equation (4) defined below:

$$RAi = \frac{Di}{R * dli} \times 100 \qquad ( 4 )$$

FIG. 4A illustrates a Technique for Order of Preference by Similarity to Ideal Solution (TOPSIS) score calculation algorithm, according to certain embodiments. In an embodiment, the TOPSIS score calculation algorithm may be utilized for the selection of the fog nodes 102 for task offloading based on multicriteria decision-making. The TOPSIS algorithm enables the load balancing node 106 to rank and prioritize the fog nodes 102 based on their real-time computational capacity, network conditions, and energy availability, ensuring an optimal distribution of offloaded tasks.

The algorithm takes as input a number of fog nodes (N) and evaluates them based on multiple parameters, including proportion delay (P_{D}), load ((L_{F}), and residual energy (R_{E}). The TOPSIS decision-making matrix is then formulated, where each fog node performance is represented as a vector including these parameters:
Propagation delay vector (P_{D})=[Pej] for j={1, 2, . . . , N},
Load on the fog nodes vector (L_{F})=[lfⱼ] for j={1, 2, . . . , N},
Propagation delay vector of each fog (P_{D})=[Pej] for j={1, 2, . . . , N}, and
Residual Energy vector of fog nodes (R_{E})=[rej] for j={1, 2, . . . , N}.

Algorithm steps:
For i=1 to N do

### Calculate TOPSIS Decision-Making-Matrix

W=[L_{F}; P_{D}; R_{E}] for all connected fog nodes.

The TOPSIS score for each fog node is computed using a sequence of steps as described below:

### Normalization of Data (Step 1):

The algorithm normalizes the data for attributes [L_{F}; P_{D}; R_{E}] to bring them within a common scale between 0 and 1. This step ensures that the values of different attributes are comparable. The goal is to maximize all the attribute values, ensuring a fair evaluation across fog nodes. The normalized value may be obtained using an equation (5) described below:

$$Normalized Value = \frac{Actual value}{\sqrt{\sum Actual {value}^{2}}} \qquad ( 5 )$$

### Calculation of Weighted Normalized Values (Step 2):

After normalization, the weighted normalized values are calculated for each fog node by assigning specific weights (W) to the L_{F}, P_{D}, and R_{E} parameters. The weighted normalized value may be calculated using an equation (6) described below:

Weighted Value=(L_{F}×W_{L}_{_{f}})+(P_{D}×W_{P}_{ₙ})+(R_{E}×W_{R}_{ₙ}) (6)

Where W_{L}_{_{f}}, W_{P}_{ₙ}, and W_{R}_{ₙ} are the assigned weights.

The weights define the relative importance of each parameter, allowing the algorithm to prioritize critical factors such as computation load, network latency, and energy efficiency in fog node selection.

### Determination of Ideal and Negative-Ideal Solutions (Step 3):

The algorithm identifies the ideal solution, which is the maximum normalized value for all parameters, and the negative ideal solution, which is the minimum normalized value for all parameters. These solutions serve as reference points for evaluating the proximity of each fog node to the optimal and worst-case scenarios.

### Distance Calculation (Step 4):

The algorithm calculates the proximity of each task to the ideal and negative-ideal solutions using a distance measure. Particularly, the algorithm calculates the Euclidean distance of each fog node from the ideal solution

$$( {D}_{i}^{+} )$$

and the negative-ideal solution

$$( {D}_{i}^{-} ) .$$

The distance may be calculated using the equations (7) and (8) described below:

$${D}_{i}^{+} = \sqrt{{\sum }_{j = 1}^{m} {( {NormalizedValue}_{ij} - {IdealSolution}_{j} )}^{2}} \qquad ( 7 )$$

$${D}_{i}^{-} = \sqrt{{\sum }_{j = 1}^{m} {( {NormalizedValue}_{ij} - {NegativeIdealSolution}_{j} )}^{2}} \qquad ( 8 )$$

This step quantifies how close a fog node is to the best-performing node and how far it is from the least-performing node.

### TOPSIS Score Computation (Step 5):

Finally, the TOPSIS score for each fog node is computed using an equation (9) described below:

$${TOPSIS}_{i} = \frac{{D}_{i}^{-}}{{D}_{i}^{+} + {D}_{i}^{-}} \qquad ( 9 )$$

where i denotes increment value. A higher TOPSIS score indicates a more suitable fog node for task allocation. The fog node with the highest score is selected for task offloading, ensuring minimal computational delay and optimal resource utilization.

FIG. 4B illustrates a task allocation algorithm, according to certain embodiments. In an embodiment, the task allocation algorithm is designed for the efficient distribution of computational tasks (n) among multiple fog nodes (F₁, F₂, F₃, . . . , Fₙ) in a fog computing environment. The algorithm utilizes the TOPSIS score, calculated in FIG. 4A, to determine the most suitable fog node for executing each task. This ensures optimal resource utilization, load balancing, and minimal computational delay.

The task allocation algorithm takes as input a set of tasks (n), their respective processing times (t₁, t₂, t₃, . . . , tₙ), and the available fog nodes (F₁, F₂, F₃, . . . , Fₙ) in the system 100.

The output of the algorithm is an optimized assignment of tasks to fog nodes, ensuring efficient task execution with minimal resource contention.

### Algorithm Steps:

1 Initialize sets:
2 tasks (Fᵢ)=Ø (assigned tasks to Fᵢ)
3 Load (Fᵢ)=Ø (total load of machine Fᵢ)
4 for i=1 to n do
5 Assign the task i to the fog node Fₖ with the highest TOPSIS value (computed in FIG. 4A).
6 tasks (tₖ)=tasks (Fₖ)∪{i}//assign the task to fog mode Fₖ
7 Load (Pₖ)=load (Pₖ)+tᵢ//Update the TOPSIS value of fog node Fₖ
8 end

This task allocation algorithm ensures that computational tasks are assigned to the most efficient fog node, reducing processing latency, preventing bottlenecks, and optimizing distributed computing performance. The algorithm dynamically adapts to real-time conditions, making it well-suited for fog-based IoT networks, where efficient task scheduling is crucial.

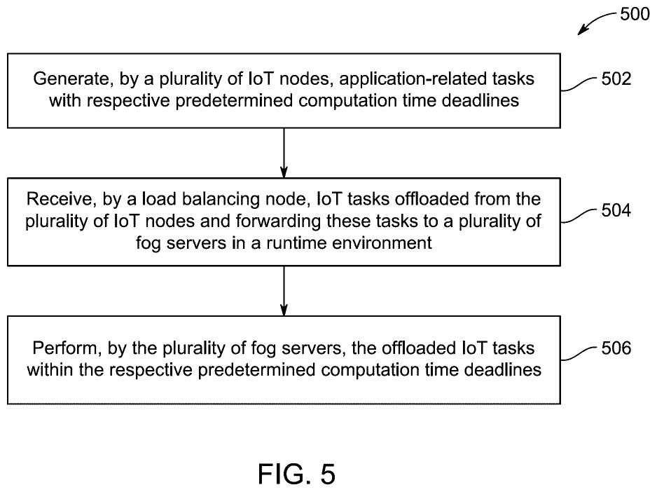

Referring now to FIG. 5, the present disclosure provides another exemplary flow diagram of a method 500 for balancing the task execution load of fog servers in the IoT network, according to certain embodiments.

In order to balance the task execution load of fog servers (e.g., the fog nodes 102), at step 502, the IoT nodes 102 may generate application-related tasks with respective predetermined computation time deadlines. In an embodiment, each of the IoT nodes 104 may initiate the IoT tasks to estimate computational time deadline requirements. The IoT tasks include performing a traffic congestion analysis from traffic data generated by one or more IoT sensors within a required computational time deadline of 1 second.

At step 504, the load balancing node 106 may receive IoT tasks offloaded from the IoT nodes 104 and forwards these tasks to the fog servers (fog nodes 102) in a runtime environment. In an embodiment, the load balancing node 106 may maintain a Technique for Order of Preference by Similarity to Ideal Solution (TOPSIS) score determined based on multicriteria decision-making for each of its connected fog servers. Further, the load balancing node 106 may calculate the TOPSIS score for the load of each connected fog server and the link quality of the load balancing node 106 with the connected fog server.

In an embodiment, multicriteria parameters of the multicriteria decision-making include link capacity between the load balancing node 106 and the fog server, a list of tasks pending in a queue of the fog server, number of under-processed tasks that are currently executing, residual energy of the fog server, and computing capacity of each of the fog servers. In an embodiment, the load balancing node 106 may run a task allocation algorithm that forwards the received offloaded task to the fog server with the highest TOPSIS score in order to minimize computational delay. In an embodiment, the load balancing node 106 may maintain a record of signal strength, tasks load, residual energy and computational resources of each connected fog server. In an embodiment, the load balancing node 106 may run a multicriteria based algorithm to determine computing capacity of the fog server.

At step 506, the fog servers (fog nodes 102) may perform the offloaded IoT tasks within the respective predetermined computation time deadlines. In an embodiment, each fog server may allocate its computing resources on each of its offloaded tasks according to their computation time deadline. In some embodiments, computing resources may be allocated based on multicore processing units of each of the fog servers. In an embodiment, a resource allocation algorithm may run on each fog server to execute the tasks placed in its queue list to complete the tasks within their computation time deadline.

The present disclosure presents a method 500 for balancing the task execution load of fog servers in the IoT network. The method 500 includes three components: tasks offloaded by IoT nodes 104 with varying deadlines, load balancing node 106, and fog nodes 102 with limited energy and computational resources. The IoT nodes 104 generate tasks, each with an assigned deadline. The load balancing node 106 interacts with multiple fog servers (fog nodes 102) and possesses knowledge of signal strength, task load, residual energy, and computational capabilities of each connected fog node. The load balancing node 106 runs a multicriteria-based algorithm to determine the computing capabilities of each fog node and assign tasks accordingly. Additionally, each fog node executes a resource allocation algorithm to process tasks in its queue while ensuring completion within their deadlines. The method 500 enables the selection of fog nodes for task offloading using the Technique for Order of Preference by Similarity to Ideal Solution (TOPSIS) score in a fog-enabled IoT network. Each fog node is assigned a TOPSIS score based on a weighted decision-making matrix, ensuring that tasks are offloaded to the most suitable node. Further, the method 500 incorporates a task allocation algorithm that dynamically assigns computational tasks to fog nodes with the highest TOPSIS score, optimizing resource utilization and reducing latency. The method 500 continuously updates the load distribution of fog nodes, ensuring efficient workload balancing and preventing congestion in heavily loaded nodes. In an embodiment, a distance-based proximity measure is utilized to refine task assignment decisions, enhancing computational efficiency in real-time fog computing scenarios. By utilizing a multicriteria based algorithm, the method 500 minimizes computational delays, optimizes resource allocation, and enhances the overall performance of fog computing infrastructure. The method 500 maximizes task execution efficiency, reduces energy consumption, and ensures seamless task processing in latency-sensitive applications such as IoT and edge computing environments.

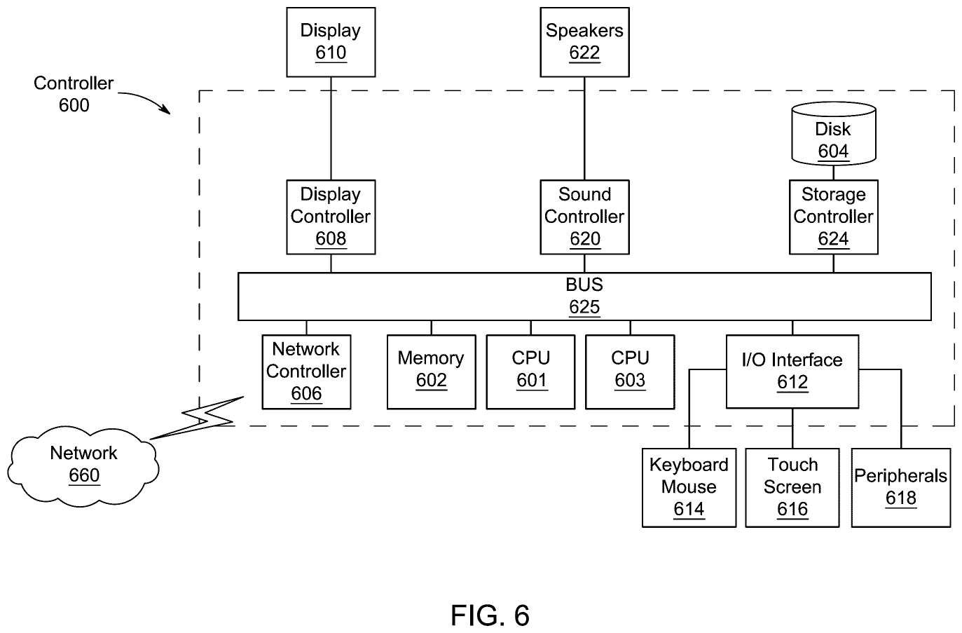

Next, further details of the hardware description of the computing environment according to exemplary embodiments are described with reference to FIG. 6. In FIG. 6, a controller 600 is described as representative of the apparatus 100 of FIG. 1 in which the controller 600 is a computing device which includes a CPU 601 which performs the processes described above/below. The process data and instructions may be stored in a memory 602. These processes and instructions may also be stored on a storage medium disk 604, such as a Hard Disk Drive (HDD) or a portable storage medium or may be stored remotely.

Further, the disclosure is not limited by the form of the computer-readable media on which the instructions of the inventive process are stored. For example, the instructions may be stored on Compact Disks (CDs), Digital Versatile Discs (DVDs), in a Flash memory, a RAM, a ROM, a Programmable Read-Only Memory (PROM), an EPROM, an Electrically Erasable Programmable Read-Only Memory (EEPROM), a hard disk or any other information processing device with which the computing device communicates, such as a server or a computer.

Further, the disclosure may be provided as a utility application, background daemon, or component of an operating system, or combination thereof, executing in conjunction with the CPU 601, a CPU 603 and an operating system such as a Microsoft Windows 7, a Microsoft Windows 10, a UNIX, a Solaris, a LINUX, an Apple MAC-OS and other systems known to those skilled in the art.

The hardware elements in order to achieve the computing device may be realized by various circuitry elements, known to those skilled in the art. For example, the CPU 601 or the CPU 603 may be a Xenon or a Core processor from Intel of America or an Opteron processor from Advanced Micro Devices (AMD) of America, or may be other processor types that would be recognized by one of ordinary skill in the art. Alternatively, the CPU 601, the CPU 603 may be implemented on a Field-Programmable Gate Array (FPGA), an Application-Specific Integrated Circuit (ASIC), a Programmable Logic Device (PLD) or using discrete logic circuits, as one of ordinary skill in the art would recognize. Further, the CPU 601, the CPU 603 may be implemented as multiple processors cooperatively working in parallel to perform the instructions of the inventive processes described above.

The computing device in FIG. 6 also includes a network controller 606, such as an Intel Ethernet Professional (PRO) network interface card from an Intel Corporation of America, for interfacing with a network 660. As can be appreciated, the network 660 can be a public network, such as the Internet, or a private network such as a LAN or a WAN, or any combination thereof and can also include a PSTN or an Integrated Services Digital Network (ISDN) sub-networks. The network 660 can also be wired, such as an Ethernet network, or can be wireless such as a cellular network including EDGE, Third Generation (3G) and Fourth Generation (4G) wireless cellular systems. The wireless network can also be a WiFi, a Bluetooth, or any other wireless form of communication that is known.

The computing device further includes a display controller 608, such as a NVIDIA GeForce Giga Texel Shader eXtreme (GTX) or a Quadro graphics adaptor from a NVIDIA Corporation of America for interfacing with a display 610, such as a Hewlett Packard HPL2445w Liquid Crystal Display (LCD) monitor. A general purpose I/O interface 612 interfaces with a keyboard and/or mouse 614 as well as a touch screen panel 616 on or separate from display 610. The general purpose I/O interface 612 also connects to a variety of peripherals 618 including printers and scanners, such as an OfficeJet or DeskJet from HP.

A sound controller 620 is also provided in the computing device such as a Sound Blaster X-Fi Titanium from Creative, to interface with speakers/microphone 522 thereby providing sounds and/or music.

A general purpose storage controller 624 connects the storage medium disk 604 with a communication bus 626, which may be an Industry Standard Architecture (ISA), an Extended Industry Standard Architecture (EISA), a Video Electronics Standards Association (VESA), a Peripheral Component Interconnect (PCI), or similar, for interconnecting all of the components of the computing device. A description of the general features and functionality of the display 610, keyboard and/or mouse 614, as well as the display controller 608, the general purpose storage controller 624, the network controller 606, the sound controller 620, and the general purpose I/O interface 612 is omitted herein for brevity as these features are known.

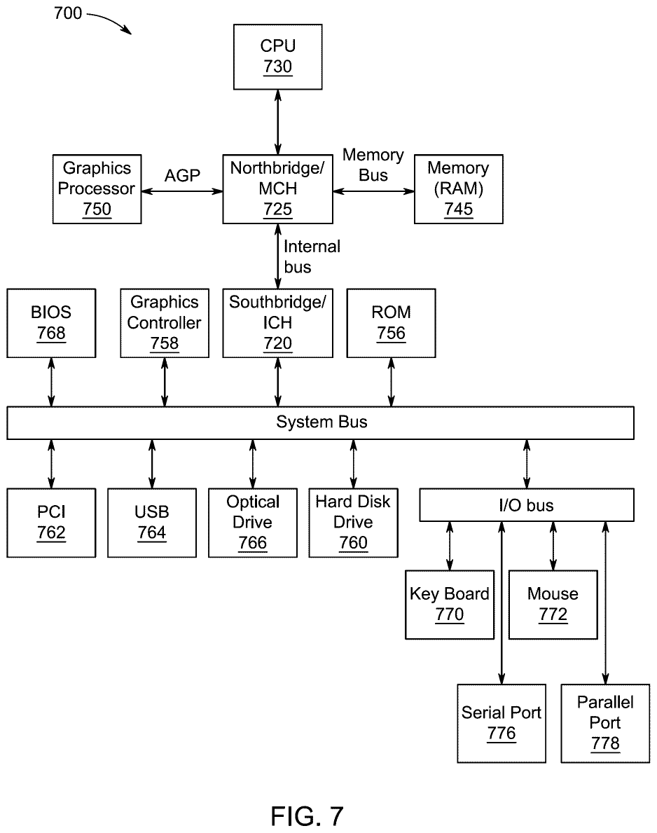

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 7.

FIG. 7 shows a schematic diagram of a data processing system 700, according to certain embodiments, for performing the functions of the exemplary embodiments. The data processing system 700 is an example of a computer in which code or instructions implementing the processes of the illustrative embodiments may be located.

In FIG. 7, the data processing system 700 employs a hub architecture including a North Bridge and a Memory Controller Hub (NB/MCH) 725 and a south bridge and an I/O Controller Hub (SB/ICH) 720. The CPU 730 is connected to the NB/MCH 725. The NB/MCH 725 also connects to a memory 745 via a memory bus and connects to a graphics processor 750 via an Accelerated Graphics Port (AGP). The NB/MCH 725 also connects to the SB/ICH 720 via an internal bus (e.g., a unified media interface or a direct media interface). The CPU 730 may contain one or more processors and even may be implemented using one or more heterogeneous processor systems.

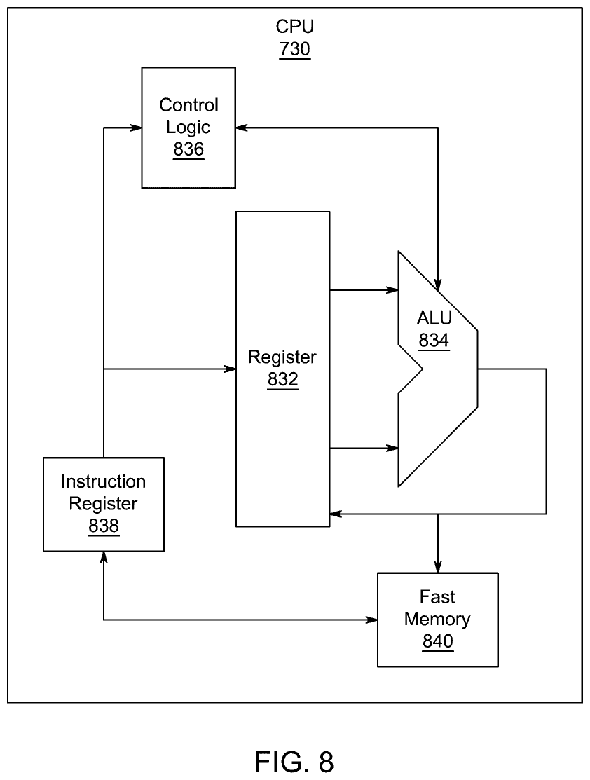

For example, FIG. 8 shows one implementation of the CPU 730. In one implementation, an instruction register 838 retrieves instructions from a fast memory 840. At least part of these instructions is fetched from the instruction register 838 by a control logic 836 and interpreted according to the instruction set architecture of the CPU 730. Part of the instructions can also be directed to a register 832. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using an Arithmetic Logic Unit (ALU) 834 that loads values from the register 832 and performs logical and mathematical operations on the loaded values according to the instructions. The results from these operations can be feedback into the register 832 and/or stored in the fast memory 840. According to certain implementations, the instruction set architecture of the CPU 730 can use a reduced instruction set architecture, a complex instruction set architecture, a vector processor architecture, a very large instruction word architecture. Furthermore, the CPU 730 can be based on a Von Neuman model or a Harvard model. The CPU 730 can be a digital signal processor, an FPGA, an ASIC, a Programmable Logic Array (PLA), a PLD, or a Complex Programmable Logic Device (CPLD). Further, the CPU 730 can be an x86 processor by the Intel or by the AMD; an Advanced Reduced Instruction Set Computing (RISC) Machine (ARM) processor, a power architecture processor by, e.g., an International Business Machines Corporation (IBM); a Scalable Processor Architecture (SPARC) processor by Sun Microsystems or by Oracle; or other known CPU architecture.

Referring again to FIG. 7, the data processing system 700 can include that the SB/ICH 720 is coupled through a system bus to an I/O Bus, a ROM 756, a Universal Serial Bus (USB) port 764, a flash Binary Input/Output System (BIOS) 768, and a graphics controller 758. PCI/PCIe devices can also be coupled to SB/ICH 720 through a PCI bus 762.

The PCI devices may include, for example, Ethernet adapters, add-in cards, and Personal Computer (PC) cards for notebook computers. The HDD 760 and an optical drive 766 (e.g., CD-ROM) can use, for example, an Integrated Drive Electronics (IDE) or a Serial Advanced Technology Attachment (SATA) interface. In one implementation, an I/O bus can include a super I/O (SIO) device.

Further, the HDD 760 and the optical drive 766 can also be coupled to the SB/ICH 720 through a system bus. In one implementation, a keyboard 770, a mouse 772, a serial port 776, and a parallel port 778 can be connected to the system bus through the I/O bus. Other peripherals and devices that can be connected to the SB/ICH 720 using a mass storage controller such as the SATA or a Parallel Advanced Technology Attachment (PATA), an Ethernet port, an ISA bus, a Low Pin Count (LPC) bridge, a System Management (SM) bus, a Direct Memory Access (DMA) controller, and an Audio Compressor/Decompressor (Codec).

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

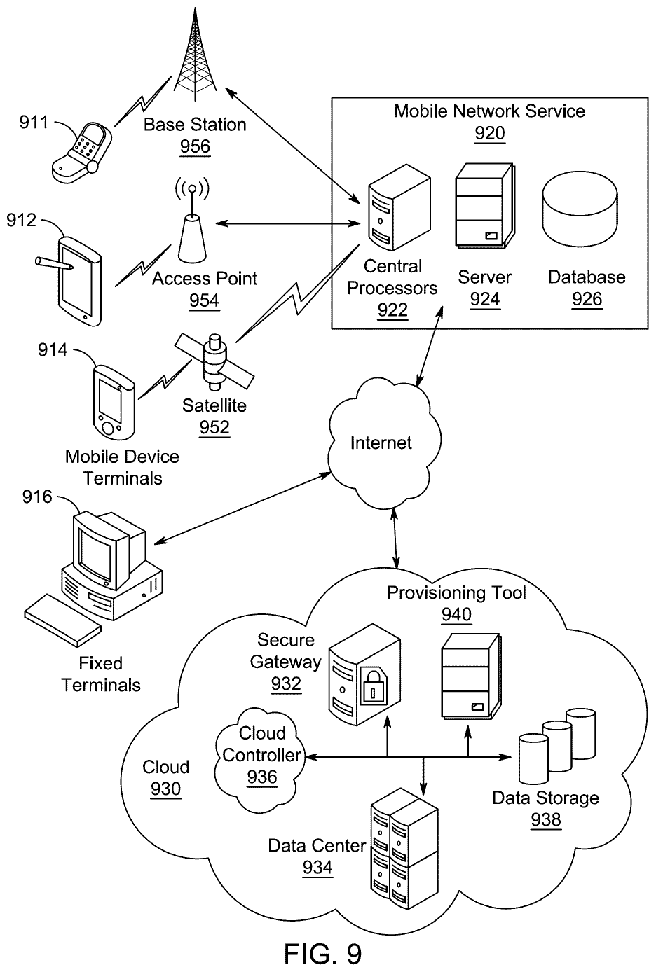

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 9, in addition to various human interface and communication devices (e.g., display monitors, smart phones, tablets, personal digital assistants (PDAs)). More specifically, FIG. 9 illustrates client devices including a smart phone 910, a tablet 912, a mobile device terminal 914 and fixed terminals 916. These client devices may be commutatively coupled with a mobile network service 920 via a base station 956, an access point 954, a satellite 952 or via an internet connection. The mobile network service 920 may comprise central processors 922, a server 924 and a database 926. The fixed terminals 916 and the mobile network service 920 may be commutatively coupled via an internet connection to functions in cloud 930 that may comprise a security gateway 932, a data center 934, a cloud controller 936, a data storage 938 and a provisioning tool 940. The network may be a private network, such as the LAN or the WAN, or may be the public network, such as the Internet. Input to the system may be received via direct user input and received remotely either in real-time or as a batch process. Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible in light of the above teachings. It is, therefore, to be understood that the invention may be practiced otherwise than as specifically described herein.

1. A system for balancing task execution load of a plurality of fog servers in an Internet of Things (IoT) network, comprising:
a plurality of IoT nodes;
the plurality of fog servers; and
a load balancing node,
wherein the plurality of IT nodes are configured to generate IoT tasks with respective predetermined computation time deadlines and offload the generated IoT tasks to the load balancing node,
wherein the plurality of fog servers are configured to provide computation resources for performing the offloaded IoT tasks within the respective predetermined computation time deadlines, and
wherein the load balancing node is configured to receive all of the offloaded IoT tasks from the plurality of IoT nodes and allocate the received offloaded IoT tasks to the plurality of fog servers in a runtime environment.

2. The system of claim 1, wherein the plurality of IoT nodes are autonomous vehicles equipped with one or more IoT sensors, and
wherein each of the plurality of IoT nodes is configured to initiate the IoT tasks with computational time deadline requirements, wherein the IoT tasks include performing a traffic congestion analysis from traffic data generated by the one or more IoT sensors within a required computational time deadline of 1 second.

3. The system of claim 1, wherein the load balancing node is configured to maintain a Technique for Order of Preference by Similarity to Ideal Solution (TOPSIS) score determined based on multicriteria decision-making for each of its connected fog servers, and wherein the load balancing node is configured to calculate the TOPSIS score for the load of the connected fog server and link quality of the load balancing node with the connected fog server.

4. The system of claim 3, wherein multicriteria parameters of the multicriteria decision-making include link capacity between the load balancing node and the fog server, a list of tasks pending in a queue of the fog server, number of under-processed tasks that are currently executing, residual energy of the fog server, and computing capacity of each of the plurality of fog servers.

5. The system of claim 1, wherein the load balancing node is configured to run a task allocation algorithm that forwards the received offloaded IoT task to one of the plurality of fog servers that has a highest TOPSIS score in order to provide minimum computational delay.

6. The system of claim 1, wherein each fog server is configured to allocate its computing resources on each of its offloaded task according to their computation time deadline.

7. The system of claim 1, wherein each of the plurality of fog servers has multicore processing units.

8. The system of claim 1, wherein the load balancing node is configured to maintain a record of signal strength, tasks load, residual energy and computational resources of each connected fog server.

9. The system of claim 1, wherein the load balancing node is configured to run a multicriteria based algorithm to determine computing capacity for each of the plurality of fog servers.

10. The system of claim 1, wherein each fog server is configured to run a resource allocation algorithm to execute the tasks placed in a queue list of the fog server to complete the tasks within their computation time deadline.

11. A method, by a load balancing node, for balancing task execution load of a plurality of fog servers in an Internet of Things (IoT) network that includes a plurality of IoT nodes, comprising:
generating, by the plurality of IoT nodes, IoT tasks with respective predetermined computation time deadlines;
offloading, by the plurality of IoT nodes, the generated IoT tasks to the load balancing node;
receiving, by the load balancing node, the offloaded IoT tasks from the plurality of IoT nodes and allocating the received offloaded IoT tasks to the plurality of fog servers in a runtime environment; and
performing, by the plurality of fog servers, the offloaded IoT tasks within the respective predetermined computation time deadlines.

12. The method of claim 11, wherein the plurality of IoT nodes are autonomous vehicles equipped with one or more IoT sensors, the method further comprising initiating, by each of the plurality of IoT nodes, the IoT tasks to estimate computational time deadline requirements, wherein the IoT tasks include performing a traffic congestion analysis from traffic data generated by the one or more IoT sensors within a required computational time deadline of 1 second.

13. The method of claim 11, further comprising:
maintaining, by the load balancing node, a Technique for Order of Preference by Similarity to Ideal Solution (TOPSIS) score determined based on multicriteria decision-making for each of its connected fog servers; and
calculating, by the load balancing node, the TOPSIS score for the load of each connected fog server and link quality of the load balancing node with the connected fog server.

14. The method of claim 13, wherein multicriteria parameters of the multicriteria decision-making include link capacity between the load balancing node and the fog server, a list of tasks pending in a queue of the fog server, number of under-processed tasks that are currently executing, residual energy of the fog server, and computing capacity of each of the fog servers.

15. The method of claim 11, further comprising running, by the load balancing node, a task allocation algorithm that forwards the received offloaded IoT task to one of the plurality of fog servers that has a highest TOPSIS score in order to minimize computational delay.

16. The method of claim 11, further comprising allocating, by each fog server, its computing resources on each of its offloaded tasks according to their computation time deadline.

17. The method of claim 16, further comprising allocating computing resources based on multicore processing units of each of the plurality of fog servers.

18. The method of claim 11, further comprising maintaining, by the load balancing node, a record of signal strength, tasks load, residual energy and computational resources of each connected fog server.

19. The method of claim 11, further comprising running, by the load balancing node, a multicriteria based algorithm to determine computing capacity of the fog server.

20. The method of claim 11, further comprising running a resource allocation algorithm on each fog server to execute the tasks placed in a queue list of the fog server to complete the tasks within their computation time deadline.
